(19) United States
(12) Patent Application Publication
(10) Pub. No.: US 2006/0076187 A1
(43) Pub. Date: Apr. 13, 2006

(54) Ladder handle

(76) Inventor: Maria Eugenia Meza, Lake Worth, FL (US)

Correspondence Address: OTTO S KAUDER, 5382C Venetia Ct., Boynton Beach, FL, 33437, US

(21) Appl. No.: 11/102,174

(22) Filed: Apr. 11, 2005

Related U.S. Application Data
(60) Provisional application No. 60/616,876, filed on Oct. 8, 2004.

(51) Int. Cl. E06C 9/00

(52) U.S. Cl. 182/77

(57) ABSTRACT

There is disclosed improvement of a ladder having a plurality of sections, the bottom section being capable of motion independently of other sections, such as an attic type or disappearing type ladder, by a handle affixed to a section assisting a user to lower and raise the ladder, and a fastener assembly releasably fastening two sections of the ladder together until released by the user.

### CROSS-REFERENCE TO RELATED APPLICATION

This application is a continuation of Provisional Patent Application No. 60/616876 filed Oct. 8, 2004.

### BACKGROUND OF THE INVENTION

### Field of the Invention

The invention relates to a ladder, particularly the so-called attic ladder or disappearing ladder. When not in use, such a ladder is stored within the attic, folded in a plurality of sections such that the angle between adjacent sections is close to zero degrees. When used to provide access to the attic from the floor below, the attic door holding the ladder in place is opened, thus allowing the sections of the ladder to drop and align themselves in a staircase in which the angle between adjacent sections is approximately 180 degrees. The invention further relates to a handle assembly able to facilitate moving the ladder from its stored position to its position for use and back to its stored position, and to a method of moving the ladder from its stored position to its position for use and back to its stored position with the help of the handle assembly.

Ladders of the general type described are commercially available and installed in many residences in the United States and elsewhere. However, the attic doors and the sections of the ladder are conventionally sized in such a way that the ladder can only drop down through the attic door in the fully folded state and can be difficult for persons of ordinary stature to reach and manipulate from below.

Therefore, a need still exists for easier access to and maneuverability of the so-called attic ladder or disappearing sectional ladder.

### SUMMARY OF THE INVENTION

It is accordingly an object of the invention to provide an improvement of a ladder having a plurality of sections, such as an attic type or disappearing type ladder to make it easier to install, to access, to maneuver and use, and to return to its stored position.

With the foregoing and other objects in view there is provided, in accordance with the invention, a ladder comprising a top section, a middle section, and a bottom section, in which the bottom section can move independently of other sections, a handle affixed to a section to assist a user in lowering and raising the ladder, and a fastener assembly releasably fastening two sections of the ladder together until released by the user.

There is also provided, in accordance with this invention, a method of unfolding a ladder having a plurality of sections from a folded storage position to an extended use position, comprising the steps of

providing a ladder having a plurality of sections, a handle affixed to a section, and a fastener assembly releasably fastening two sections of the ladder together in a folded configuration within a storage space and restrained from falling by a door disposed beneath the ladder;

opening the door to permit the ladder to drop to a first position, where the handle can be accessed;

releasing the handle from its stored position;

pulling the handle to cause the two fastened sections of the ladder to move forward and downward to a second position below the first position;

opening the fastener so as to enable the sections fastened together to be separated; and

extending the separated sections in an approximately straight line configuration to enable the ladder to be used.

There is, moreover, provided, in accordance with this invention, a method of folding a ladder having a plurality of sections from an extended use position to a folded storage position, comprising the steps of

providing a ladder having a plurality of sections, a handle affixed to a section, and an open fastener assembly, the ladder being in an unfolded configuration;

closing the fastener;

pushing the handle upward to cause the sections to assume a partially folded zigzag configuration;

pushing the handle further upward to bring the fastened sections to rest against the remaining section in a folded configuration; in which it can be conventionally put away in the storage space above the door.

The ladder handle and fastener according to the invention can advantageously further comprise one or more of the following features:

Thus, the ladder according to the invention can have a top section, a middle section, and a bottom section. The handle according to the invention is preferably affixed to the middle section.

The fastener assembly preferably fastens the bottom section of the ladder to the middle section. The sections are kept fastened together when the ladder is folded away out of use, and when the folded ladder is caused to drop through the opened attic door in order to permit use of the ladder. Once the ladder is below the opened attic door, the fastener can be released to enable the sections of the ladder to be unfolded and extended. Any convenient fastener can be used. A preferred type of fastener has a movable member affixed to one section of the ladder that can be inserted in a receptacle affixed to an adjacent section of the ladder to fasten the sections together, and is unfastened by withdrawing the movable member from the receptacle. A simple hand operated latch and catch assembly or hook and eye fastener, with the latch or hook affixed to one of the sections and the catch or eye affixed to the adjacent sections, is particularly suitable in most situations. For special needs, a remotely controlled fastener can be installed.

The ladder handle according to the invention is a rigid pole, tube, or rod, solid or hollow. The handle has a proximate end affixed to the ladder, and a distal end accessible to the user. The length of the handle is a function of the length of the section of the ladder to which it is affixed, and is usually nearly (i.e. 70-98%) as long as the section. The handle can have any esthetically desirable shape, particularly with a round, oval, flat, square or free form shape. A hollow tube of approximately circular shape is preferred. The handle is suitably flattened near the proximate end affixed to the ladder.

The handle can be affixed to a section of the ladder, suitably the middle section, by means of a hole near the proximate end, suitably within two inches of the end. A bolt and nut, pin and cotter pin, washers, and any other convenient method of securing the handle to the ladder section can be used. When not being used, the handle can be stored alongside the ladder section to which it is affixed. The distal end of the handle can be held in place along the ladder section by a C-type or U-type clamp, also known as a one hole strap.

If desired, the handle can also include a hand grip of material preferably having non-slip character, such as sponge, cloth, leather, rubber or plastic, surrounding the distal end of the handle.

The handle can be made of any convenient rigid material including wood, metal such as steel, aluminum, brass or suitable alloy, plastic such as pvc, polyolefin, polystyrene, composites and combinations thereof.

Although the invention is illustrated and described herein as embodied in a ladder and handle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a perspective with a cross-section view of a ladder handle according to the invention including optional hand grip and holes for passage of mounting screw.

FIG. 2 is a front view of the handle, with the back being a mirror image of that shown,

FIG. 3 is a right side view of the handle, being identical to the left view.

FIG. 4 is a top view of the handle, being identical to a bottom view.

FIG. 5 is a partial perspective view of an alternative embodiment of the ladder handle.

FIG. 6 is a view of a door hiding a sectional ladder assembly according to the invention in a closed position.

FIG. 7 is a perspective view of the sectional ladder assembly in an open and folded position, showing the handle according to the invention.

FIG. 8 is a perspective view of the sectional ladder assembly according to the invention in an open and partially extended position with the handle released.

FIG. 9 is a perspective view of the sectional ladder assembly according to the invention in a position with the middle section extended and the bottom section fastened to the middle section.

FIG. 10 is a perspective view of the sectional ladder assembly according to the invention with all sections open and free to move.

FIG. 11 is a perspective view of the sectional ladder assembly according to the invention in a position with the two upper sections extended, bent at the joints,

FIG. 12 is a perspective view of the sectional ladder assembly according to the invention in a fully extended position showing a straight line configuration with the handle in stored position.

FIG. A-A is an exploded view through the ladder handle assembly of FIG. 10 along the line A-A

FIG. 13 is a close-up detail of FIGS. 7-10 showing the bottom section of the ladder attached to the middle section.

### DESCRIPTION OF PREFERRED EMBODIMENTS

Referring now to FIG. 1, the handle 1 is shown in a perspective view with a cross section to visualize a hollow cylindrical tube, having an optional hand grip 2 at the distal end and a hole 3 traversing the handle at a right angle to its length near the proximate end.

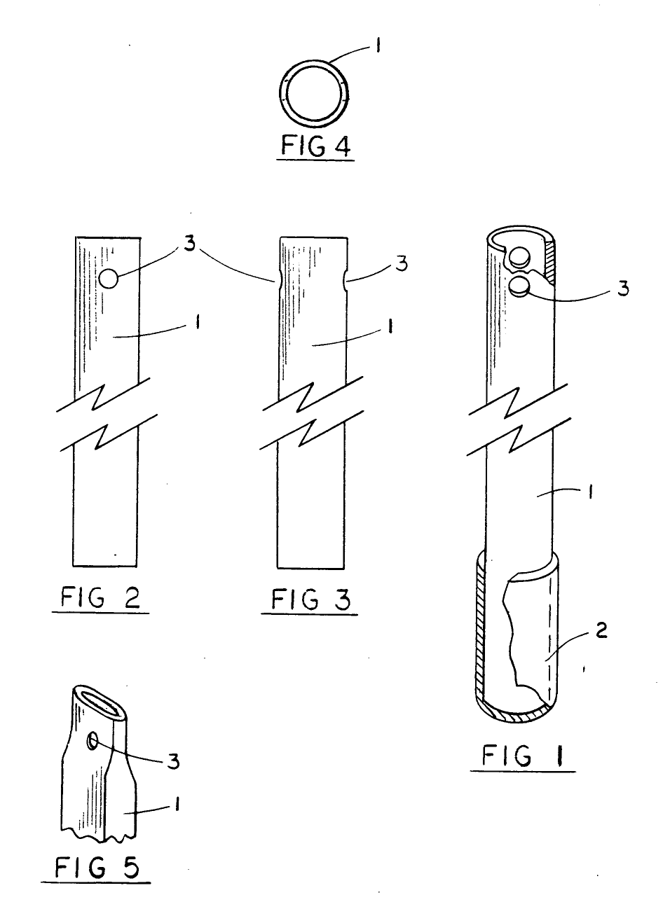

FIG. 2 is a front view (opposite back identical) of the hollow tube handle 1, showing the hole 3.

FIG. 3 is a side view (opposite side mirror image of the hollow tube handle 1, showing the hole 3

FIG. 4 is a top view of the hollow tube handle 1 (bottom view being identical).

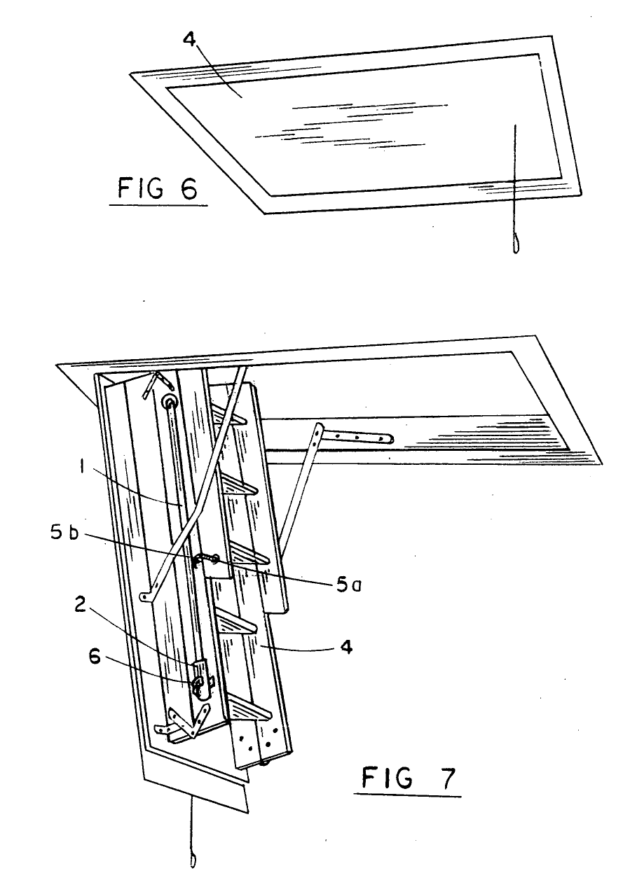

FIG. 5 shows a modification of the handle of FIG. 1, in which the proximate end including hole 3 is flat to facilitate affixing the handle 1 to a section of a ladder.

An attic ladder 4 in its stored or closed configuration is shown in FIG. 6. The ladder 4 is held in place by a conventional attic door fitted with a pull string.

Opening the attic door by the pull string enables the attic ladder 4 to drop through the opening in its folded configuration, as shown in FIG. 7. Handle 1 is shown affixed at its proximate end to the middle section of the ladder 4. As shown, the handle extends for approximately three quarters of the length of the middle section of the ladder. The distal end of the handle with optional hand grip 2 is held in place by one-hole strap or U-clamp 6. The middle and bottom sections of the ladder are fastened together by latch and catch assembly, 5

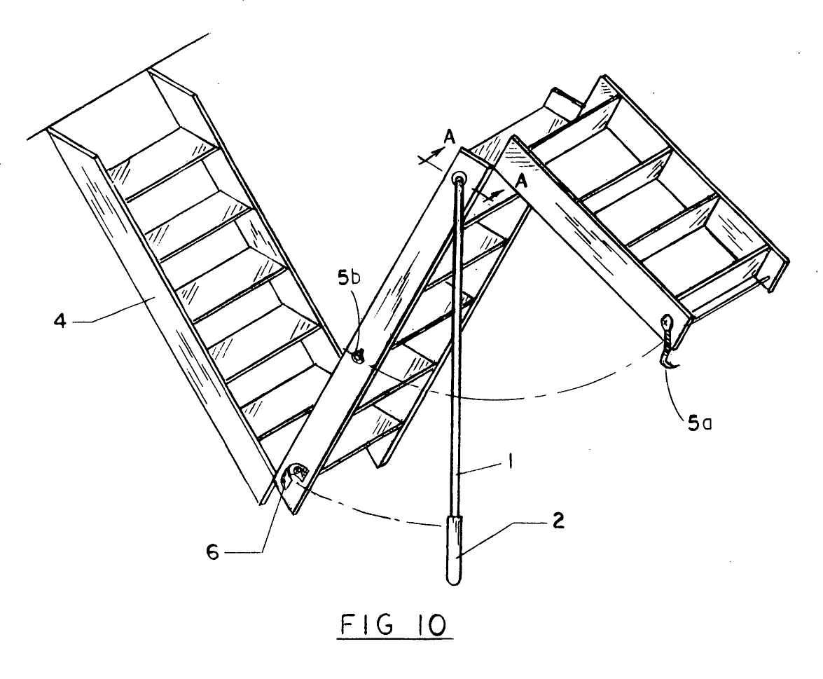

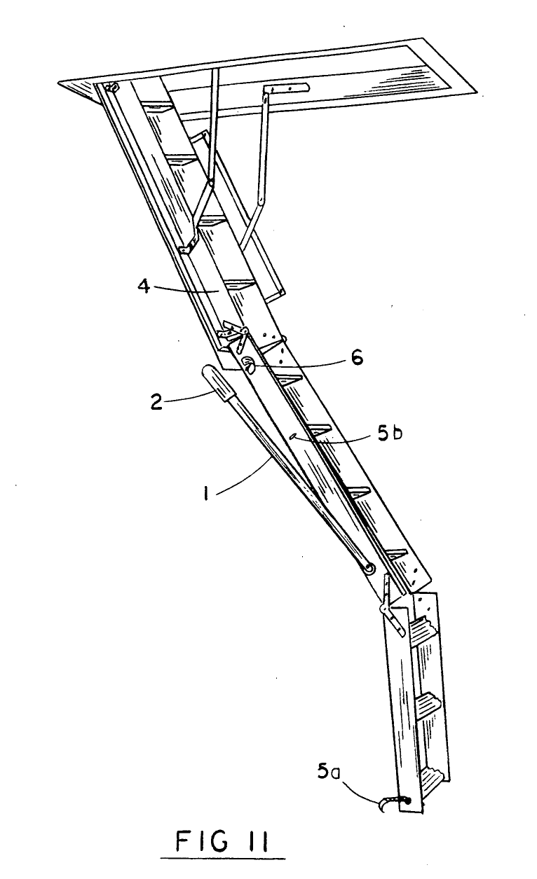

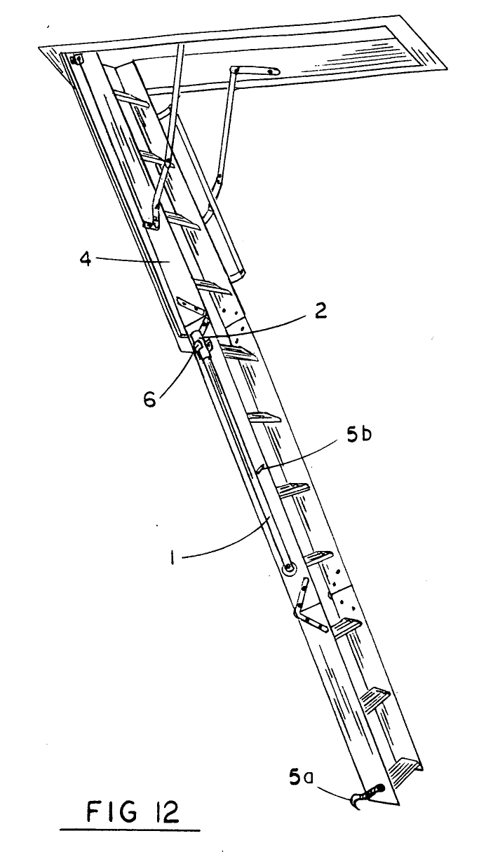

To extend the attic ladder 4, the user grasps the distal end of handle 1 by the optional hand grip, releasing it from the one-hole strap 6. The user then pulls on the handle 1, causing the bottom and middle sections of the ladder fastened together by fastener 5 to move forward and downward past the edge of the attic door, as shown progressively in FIGS. 7 through 9. Next, the user is able to access and open the fastener 5, as by separating the latch 5a from the catch 5b, to enable the bottom section to swing free of the middle section at one end, as shown in FIG. 10. It is important to keep the middle and bottom sections of the ladder 4 fastened together until they have moved past the edge of the attic door because that motion would be blocked by the edge of the opening if the sections were not fastened. In this way, the handle 1 and fastener 5 cooperate according to the invention to facilitate the lowering of the attic ladder 4 from its stored position to its extension reaching floor level.

FIG. 11 shows the attic ladder according to the invention almost completely extended, with the joints between sections bent and with the handle 1 about to be stored by replacing its distal end including optional hand grip 2 in one-hole strap (U-clamp or C-clamp) 6.

FIG. 12 shows the attic ladder 4 according to the invention fully extended and ready for use, with the sections locked into a straight line configuration.

FIG. A-A being an exploded view on FIG. 10 along the line A-A illustrates one way to affix the handle 1 to the ladder 4 by means of a screw 7 passing successively through a washer 8, hole 3 in handle 1, a second washer 8, the ladder 4, a third washer 8 and a nut 9.

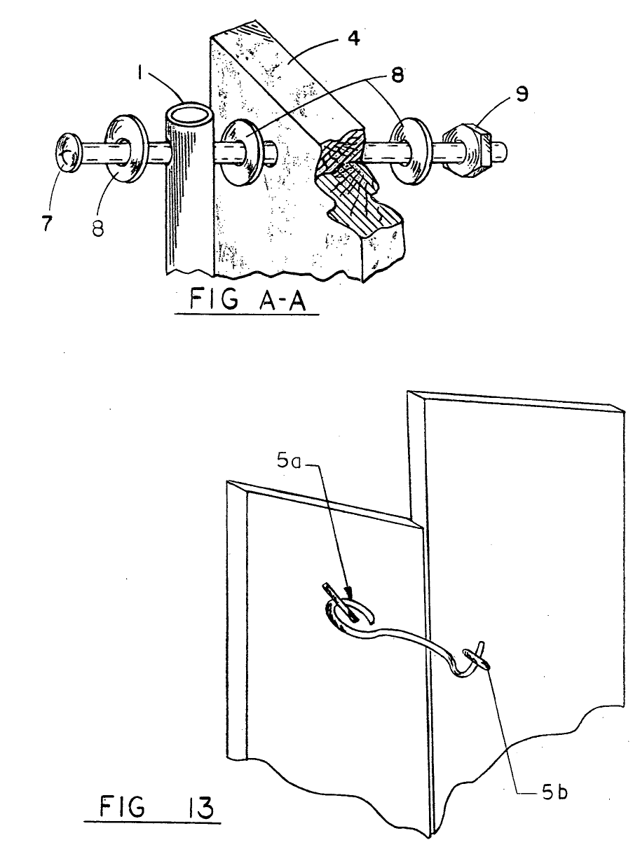

FIG. 13 illustrates an enlarged detail of a fastener 5, with a latch 5a affixed to a section of ladder 4 and a catch 5b affixed to an adjacent ladder 4 section.

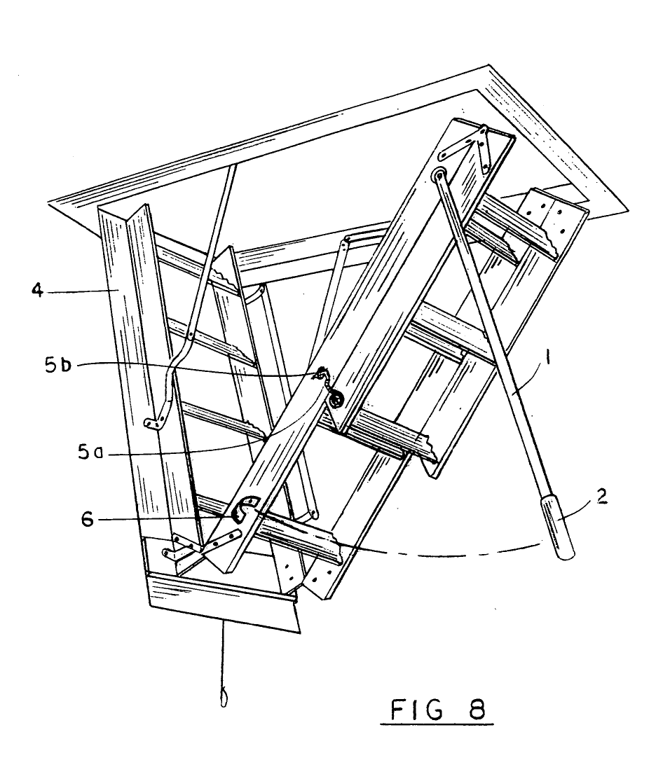

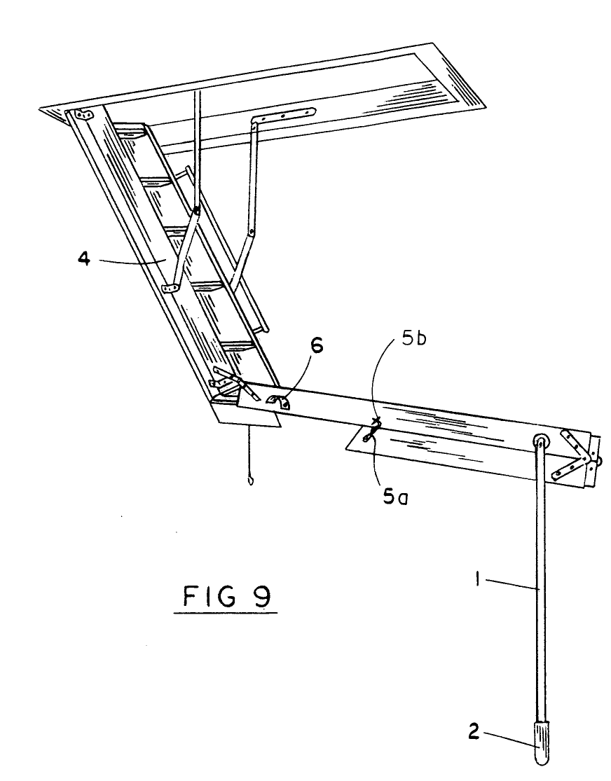

In order to return the ladder according to the invention to its folded and stored position after use, the user bends the sections of ladder 4 at the joints to return from the position of FIG. 12 to the position of FIG. 11, releases the hand grip 2 at the distal end of handle 1 from one-hole strap 6 and pushes the handle 1 upward to a position as shown in FIG. 10. Then the user closes fastener 5, insetting latch 5a into catch 5b, to fasten the bottom and middle sections of the ladder 4 together as shown in FIG. 9. A further push on the handle 1 moves the fastened bottom and middle sections of the ladder 4 through the position shown in FIG. 8 past the edge of the attic opening into the fully folded position of FIG. 7, where the handle 1 can then be stored by reinserting hand grip 2 in one-hole strap 6. The folded attic ladder 4 can then be replaced inside the attic door.

I claim:

1. A ladder comprising a top section, a middle section, and a bottom section, said bottom section being capable of motion independently of said middle section, a handle affixed to a section assisting a user to lower and raise said ladder, and a fastener assembly releasably fastening two sections of said ladder.

2. The ladder of claim 1, wherein said handle is affixed to the middle section.

3. The ladder of claim 1, wherein said fastener assembly fastens said bottom section to said middle section.

4. The ladder of claim 3, wherein said fattener assembly comprises a latch and catch assembly.

5. The ladder of claim 1, wherein said handle has a round shape.

6. The ladder of claim 5, wherein said handle is a solid rod.

7. The ladder of claim 5, wherein said handle is a hollow tube.

8. The ladder of claim 1, wherein said handle has a flat shape.

9. The ladder of claim 1, wherein said handle is flattened near the end affixed to the ladder.

10. The ladder of claim 1, additionally comprising a hand grip at the distal end of said handle.

11. In a ladder comprising a plurality of sections, the improvement comprising a handle affixed to a section assisting a user to lower and raise the ladder, and a fastener assembly releasably fastening two sections of said ladder.

12. A method of unfolding a ladder according to claim 1, comprising the steps of providing a ladder according to claim 1;
causing the ladder to move to a first position permitting access to the handle,
pulling the handle to cause the two fastened sections of the ladder to move forward and downward to a second position below the first position;
opening the fastener so as to enable the sections fastened together to be separated; and
extending the separated sections in an approximately straight line configuration to enable the ladder to be used.

13. A method of folding a ladder according to claim 1, comprising in sequence the steps of
providing a ladder according to claim 1, the ladder being in an unfolded configuration;
pushing the handle upward to cause the sections to assume a partially folded zigzag configuration;
closing the fastener;
pushing the handle further upward to bring the fastened sections to rest against the remaining section in a folded configuration, restoring the handle to a stored position, and
closing the attic door.
